(19) United States
(12) Patent Application Publication
(10) Pub. No.: US 2014/0304668 A1
(43) Pub. Date: Oct. 9, 2014

(54) VIA DESIGN SYSTEM

(71) Applicant: HON HAI PRECISION INDUSTRY CO., LTD., New Taipei (TW)

(72) Inventor: KUN-HUNG TSAI, New Taipei (TW)

(21) Appl. No.: 13/945,879

(22) Filed: Jul. 18, 2013

(30) Foreign Application Priority Data
Apr. 9, 2013 (TW) 102112466

(51) Int. Cl. G06F 17/50

(52) U.S. Cl. CPC G06F 17/5045
USPC 716/106

(57) ABSTRACT

A via design system includes a processor to execute operations of displaying a via design interface. The via design interface includes a data input area and a result display area. The data input area is for inputting a variety of data for designing a via. An actual impedance Zvia and an ideal impedance Zc are computed according to the input data and preset equations, and an impedance comparison graph according to the actual impedance Zvia and the ideal impedance Zc, is drawn. The impedance comparison graph is output to the result display area.

### BACKGROUND

1. Technical Field

The present disclosure relates to printed circuit board (PCB) technology, and particularly to a system to design vias.

2. Description of Related Art

In designing a via of a PCB, simulations are executed using computer simulation technology to design an optimal. However, using conventional PCB computer simulation technology is time consuming.

### BRIEF DESCRIPTION OF THE GRAPHS

Many aspects of the present disclosure should be better understood with reference to the following graphs. The units in the graphs are not necessarily drawn to scale, the emphasis instead being placed upon clearly illustrating the principles of the present disclosure. Moreover, in the graphs, like reference numerals designate corresponding portions throughout the several views.

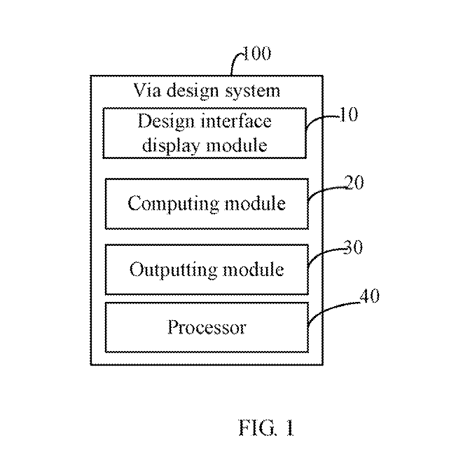

FIG. 1 is a block diagram of a via design system, in accordance with an exemplary embodiment.

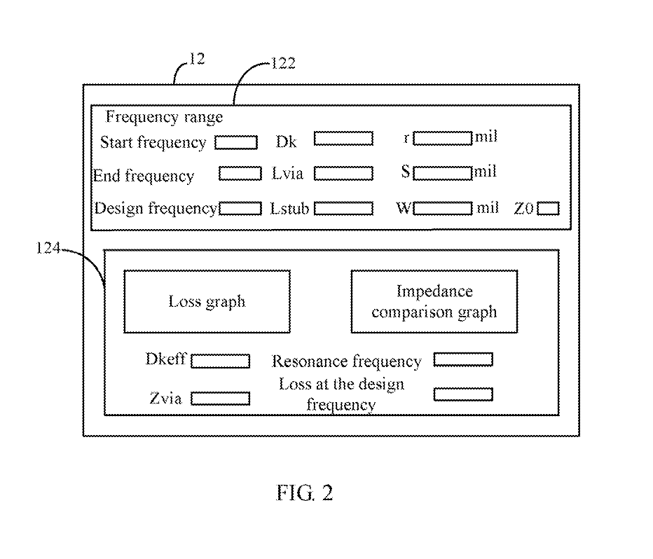

FIG. 2 is a schematic view of a via design interface provided by the via design system of FIG. 1, in accordance with an exemplary embodiment.

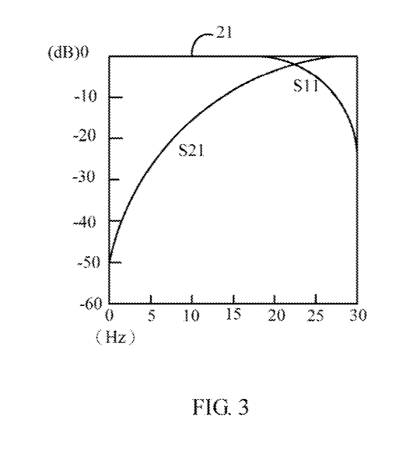

FIG. 3 is a schematic view of an impedance comparison graph provided by the via design system of FIG. 1, in accordance with an exemplary embodiment.

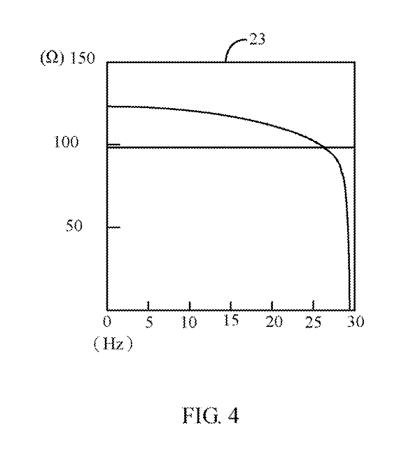

FIG. 4 is a schematic view of a loss graph provided by the via design system of FIG. 1, in accordance with an exemplary embodiment.

### DETAILED DESCRIPTION

Embodiments of the present disclosure are now described in detail, with reference to the accompanying graphs.

Referring to FIG. 1, an embodiment of a via design system 100 includes a design interface display module 10, a computing module 20, an outputting module 30, and one or more processors 40 to execute the above-mentioned modules.

Referring to FIG. 2, the design interface display module 10 displays a via design interface 12. The interface 12 includes a data input area 122 and a result display area 124. The data input area 122 is for inputting a variety of data for designing a via. In this embodiment, the variety of data includes a frequency range to be observed, a design frequency, a dielectric constant Dk, a via length Lvia, a stub length Lstub(the via length Lvia does not include the stub length Lstub), a drill radius r, a via-to-via pitch S, an anti-pad radius W, and a reference impedance Z0.

The computing module 20 computes an actual impedance Zvia and an ideal impedance Zc according to the input data and preset equations, and draws an impedance comparison graph 21 according to the actual impedance Zvia and the ideal impedance Zc (see FIG. 3), where Zvia=60/\sqrt{Dk}×{square root over (ln(S/2r+\sqrt{(S/2r)²}−1)×ln((3W+S/2)/4r))}, Zc=Z0²×(sin(θ1+θ2)/sin θ1 cos θ2), θ1=2πf/(C/\sqrt{Dk})×Lvia, θ2=2πf/(C/\sqrt{Dk})×Lstub, and C is the speed of light. The outputting module 30 outputs the impedance comparison graph 21 to the result display area 124. Designers can determine whether or not a via designed according to the input data is an optimal via according to the impedance comparison graph 21. When a difference between the actual impedance Zvia at the design frequency and the ideal impedance Zc is greater than a preset value, the via designed according to the input data is not optimal. When the via designed according to the input data is not optimal, the designers can adjust the data using the data input area 122.

The computing module 20 further computes an input loss S21 and a reactive loss S11 according to the input data and preset equations, and draws a loss graph 23 according to the input loss S21 and the reactive loss S11 (see FIG. 4), where S21=2/(2cos θ1−sin θ1sin θ2/cos θ2+j(Zc/Z0+Z0/Zc)sin θ1+jZ0/Zc×cos θ1sin θ2/cos θ2, S11=1—|S21|². The outputting module 30 outputs the loss graph 23 to the result display area 124. The designers can determine how to adjust the input data to decrease loss according to the loss graph 23.

The computing module 20 further determines a resonance frequency f1 and a loss value of the reactive loss S11 at the design frequency according to the loss graph, where the loss value of the reactive loss S11 is least at the resonance frequency f1. The outputting module 30 further outputs the resonance frequency f1 and the loss value of the reactive loss S11 at the design frequency to the result display area 124.

The computing module 20 further computes an equivalent dielectric constant Dkeff according to the input data and a preset equation, where Dkeff=Dk×((ln(S/2r+{square root over ((S/2r)²−1))})/ln((3W+S/2)/4r)). The outputting module 20 further outputs the equivalent dielectric constant Dkeff to the result display area 124.

With the design system 100, the designers can quickly determine an optimal via according to the result displayed in the result display area 124.

Although the present disclosure has been specifically described on the basis of the exemplary embodiment thereof, the disclosure is not to be construed as being limited thereto. Various changes or modifications may be made to the embodiment without departing from the scope and spirit of the disclosure.

1. A via design system comprising:
one or more processors; and
a plurality of modules comprising instructions executed by the one or more processors to perform operations for designing a via, the operations comprising:
displaying a via design interface, the via design interface comprising a data input area and a result display area, the data input area being for inputting a variety of data for designing a via, the variety of data comprising a design frequency f, a dielectric constant Dk, a via length Lvia, a stub length Lstub, a drill radius r, a via-to-via pitch S, an anti-pad radius W, and a reference impedance Z0;
computing an actual impedance Zvia and an ideal impedance Zc according to the input data and preset equations, and graph an impedance comparison graph according to the actual impedance Zvia and the ideal impedance Zc, wherein Zvia=60/\sqrt{Dk}×{square root over (ln(S/2r+\sqrt{(S/2r)²}−1)×ln((3W+S/2)/4r))}, Zc=Z0²×(sin(θ1+θ2)/sin θ1 cos θ2), θ1=2πf/(C/\sqrt{Dk})×Lvia, θ2=2πf/(C/\sqrt{Dk})×Lstub, and C is the speed of light; and
outputting the impedance comparison graph to the result display area.

2. The system as described in claim 1, wherein the operations further comprising:
computing an equivalent dielectric constant Dkeff according to the input data and a preset equation, the preset equation being Dkeff=Dk×((ln(S/2r+{square root over ((S/2r)²−1))})/ln((3W+S/2)/4r)); and
outputting the equivalent dielectric constant Dkeff to the result display area.

3. The system as described in claim 1, wherein the operations further comprising:
computing an input loss S21 and an reactive loss S11 according to the input data and preset equations, and graph a loss graph according to the input loss S21 and the reactive loss S11, wherein S21=2/(2cos θ1−sin θ1sin θ2/cos θ2+j(Zc/Z0+Z0/Zc)sin θ1+jZ0/Zc×cos θ1sin θ2/cos θ2, S11=1—|S21|²; and
outputting the loss graph to the result display area.

4. The system as described in claim 3, wherein the operations further comprising:
determining a resonance frequency f1, wherein the loss value of the reactive loss S11 is least at the resonance frequency f1; and
outputting the resonance frequency f1 to the result display area.

5. The system as described in claim 3, wherein the operations further comprising:
determining a loss value of the reactive loss S11 at the design frequency according to the loss graph; and
outputting the loss value of the reactive loss S11 at the design frequency.
